(19) United States
(12) Patent Application Publication
(10) Pub. No.: US 2005/0038197 A1
(43) Pub. Date: Feb. 17, 2005

(54) Ultra_high molecular weight hybrid dendrigraft architectures

(76) Inventors: Donald A. Tomalia, Midland, MI (US); Douglas R. Swanson, Mt. Pleasant, MI (US)

Correspondence Address: MCKELLAR STEVENS & HILL PLLC, 784 SOUTH POSEYVILLE ROAD, MIDLAND, MI, 48640, US

(21) Appl. No.: 10/639,939

(22) Filed: Aug. 13, 2003

(51) Int. Cl. C08F 271/02

(52) U.S. Cl. 525/279

(57) ABSTRACT

Mono-reactive dendrigrafts prepared by convergent self-branching polymerization and their subsequent grafting to linear, dendritic, and dendrigraft, branched, and hyper-branched substrates to prepare ultra-high molecular weight dendrigraft architectures using alkyl halides and aryl halides as initiators.

This invention deals with mono-reactive random branched dendrigrafts prepared by convergent self-branching polymerization and their subsequent grafting to linear, dendrimeric, dendrigraft, branched, and hyper-branched substrates to prepare ultra-high molecular weight hybrid dendrigraft architectures.

### BACKGROUND OF THE INVENTION

In contrast to traditional polymers, dendrimers are unique core-shell structures possessing three basic architectural components, namely, a core, an interior of shells (generations) consisting of repetitive branch cell units, and terminal functional groups, that form the outer shell or periphery of the dendrimer.

Early developments in the field were based on divergent methods of polymerization, that is, the process that generates dendrimers by successive addition of layers of monomers, first to a central core molecule, then to the growing dendrimer proceeding radially in an outwardly fashion.

Generally, the convergent polymerization approach constructs these macromolecules from the chain ends and proceeds towards the center. The process begins by adding the “peripheral” moieties to the monomer to generate small dendritic fragments or dendrons. Repetitive activation of the intermediate dendrons followed by coupling to additional monomer affords larger intermediates, which, if desired, can be attached to a central core to yield the final dendrimer.

Since the first dendrimer synthesis was reported in the mid-1980's, dendritic polymers including dendrons, dendrimers, dendrigrafts, and random hyper-branched polymers have quickly become recognized as the fourth major class of macro molecular architecture. This fourth category exhibits very different properties compared to the traditional linear, branched, and crosslinked polymers. For example, the dendritic polymers possess smaller sizes, lower viscosities, higher number of surface functional groups, faster reaction kinetics, and controlled interior void spaces, when compared with their traditional counterparts. The well-defined dendrons, dendrimers, and dendrigrafts are normally prepared via a stepwise synthetic process that often makes them too expensive to be utilized in many industrial applications. The less expensive dendrimer analogs, random hyper-branched polymers, have mostly been prepared through polycondensation of ABₓ monomers wherein x is 2 or greater.

However, due to difficulties associated with condensation reactions, the molecular weights of these polymers were generally low, and new monomer syntheses were often required. Very recently, Frechet and his coworkers developed a self-condensing vinyl polymerization approach, in which an AB monomer having both an initiating center and a propagating center was utilized to produce random hyper-branched polymers. Since each AB monomer has an initiating center, a large amount of initiator, on the order of one equivalent to one equivalent of the monomer, had to be utilized in this polymerization.

One example of the divergent polymerization approach can be found in U.S. Pat. No. 5,631,329 that issued May 20, 1997 to Yin et al in which there is disclosed forming a first set of branches by polymerizing monomers which are either protected against or are non-reactive to branching and grafting during polymerization, grafting that first set of branches to a core having a plurality of reactive sites capable of reacting with the reactive end units of said branches, either deprotecting or activating a plurality of monomeric units on each of the branches in the same manner as the first set of branches were formed, grafting the second set of branches to the first set of branches by reacting the reactive end units of the second set of branches with each said branch reactive site on said first set of branches and repeating the foregoing steps reiteratively to form and attach subsequent sets of branches to prior branch sets until a desired number of iterations has been effected.

An example of a convergent polymerization approach can be found in U.S. Pat. No. 5,041,516, that issued Aug. 20, 1991 to Frechet, et al in which there is produced a precise dendrimer having a polyfunctional central core connected to a periphery by a dendritic body which comprises building the macromolecule starting with the periphery, continuing through the dendritic body to form a dendritic wedge (i.e. dendron) having a single reacting group at its focal point, and then attaching the wedge through the focal point group to the central core.

Frechet, et al describes a good pictorial review of the result of convergent polymerization according to his method. It is very clear that this approach requires a large number of discreet labor-intensive reaction sequences to achieve the desired functional polymeric materials.

In a recent patent application Ser. No. 09/365,609, filed Sep. 2, 1999, Tomalia and co-inventors found a method for forming a branched polymer capable of achieving high molecular weights and a detailed reaction scheme is set forth therein to describe the method. Traditional polymer process optimization has focused on driving polymerizations toward the formation of long chain linear polymers with a minimum of branching. In the above-mentioned patent application, Tomalia teaches that a high level of branching can be incorporated into such polymers. This convergent self-branching polymerization concept takes advantage of polymerization conditions that promote chain transfer reactions to form multiple branching sites concurrently with linear chain propagation. It was found that reaction conditions that can impact the balance of branching over chain propagation may comprise, but is not limited to, monomer to initiator ratios, initiator type and structure of the monomer itself. This patent application teaches that oxazolines are typically polymerized by ring-opening polymerizations with cationic initiators such as Lewis acids or protic acids. The formation of highly linear polymers under living polymerization conditions typically involves slow conversions, the use of low monomer to initiator ratios, monomers with hindered or no alpha hydrogen, initiators with more ionic character and solvents with no protic hydrogens. In that patent application, the synthesis examples were based mainly on toluene sulfonic acid as the catalyst and the results were long chain polymers with more branching than the normal, traditional polymers.

It has now been discovered that by driving reaction conditions in exactly the opposite direction, high conversions, less ionic initiators, monomers with multiple or activated alpha protons, all allow the formation of unique, highly branched structures. Certain, lower ionic character initiators, for example alkyl halides, result in a greater level of polymer branching. It is believed, but the inventors herein should not be held to such a theory, that these initiators, that are slower, allow chain transfer reactions to compete more effectively with chain propagation, resulting in more highly branched and unique structures that have not been obtained heretofore.

Further, in addition to the initiator, the structure of the monomer, in this case, oxazolines, have an impact on the rate of chain transfer and result in highly branched polymer architecture. For example, in polymerizations of alkyl oxazolines substituted at the 2 position, there is evidence that chain transfer proceeds by abstraction of a proton from the carbon alpha to the oxazoline ring by a monomer molecule. This proton abstraction is enhanced by monomeric structures with more active protons on the alpha carbon.

Finally, since the chain transfer process is the reaction of an active growing polymer chain with a free monomeric unit, increasing the number of free monomers to growing chains increases the probability of the chain transfer reaction. The level of initiator determines the number of growing chains in the system. Thus, high monomer to initiator ratios would also be expected to increase the formation of branching.

The invention herein therefore relates to the deliberate reversal of reaction conditions away from the typically desirable conditions to form linear polymers to conditions that systematically and collectively enhance and promote rapid and self limiting branching.

### BRIEF DESCRIPTION OF THE DRAWINGS

FIG. 1A is a schematic of the polymerization mechanism of oxazoline using cationic ring opening polymerization: Initiation.

FIG. 1B is a continuation of the schematic of FIG. 1A wherein the propagation reaction is shown.

FIG. 1C is a continuation of the schematic of FIG. 1B and shows the termination reaction.

FIG. 2 is a schematic of a chain-transfer (active H nucleophile) reaction.

FIG. 3A shows a reaction schematic of branching in alkyl oxazoline polymerization done with high monomer to initiator ratio through chain transfer.

FIG. 3B follows the reaction scheme set forth in FIG. 3A through repolymerization.

FIG. 4 is an NMR spectra of the material obtained from Example

FIG. 5 is an NMR of the material of Example that has been treated with 1 hour refluxing in the presence of an equal molar amount of diisopropylethylamine.

FIG. 6 is a computer-simulated spectrum of an enamine derivative.

FIG. 7 to 12 are SEC analyses of products showing the molecular size increase with the increase of DP.

FIG. 13 MALDI-MS of benzyl bromide initiator

FIG. 14 MALDI-MS of C₁₂ bromide initiator.

FIG. 15 MALDI-MS of C₁₈ initiator.

FIG. 16 MALDI-MS of C₂₂ initiator.

FIG. 17 MALDI-MS of C₁₈ initiator where DP was 50.

FIG. 18 MALDI-MS for the series of Example 10.

FIG. 19A MALDI-MS of C₁₈ initiator where DP was 100.

FIG. 19B MALDI-MS of hydrolysis of material formed in Example 6.

### THE INVENTION

This invention deals with unique mono-reactive dendrigrafts prepared by convergent self-branching polymerization followed by their subsequent grafting to linear, dendritic, branched, hyper-branched polymers, or dendrigraft polymers to prepare ultra-high molecular weight dendrigraft hybrid architectures. The method is one in which the branching junctures are assembled in situ, that is, “self-branching” occurring in a convergent manner during polymerization of the monomers. The method is a direct, controllable synthetic methodology to dendritic polymer architectures using commercially available monomers. By “ultra-high molecular weight”, it is meant herein that such molecular weights are from about 10,000 to about 10 million.

Unlike traditional linear polymerizations that only extend the polymer chain in one dimension, this approach allows an oligomeric or polymeric molecule to grow and branch simultaneously during the polymerization.

This invention in a first embodiment is a method of preparing mono-reactive dendrigraft polymers by convergent self-branching polymerization. The method comprises reacting and polymerizing a monomer selected from monomers having at least one α-hydrogen relative to a 2-oxazoline or 2-oxazine ring in the presence of an alkyl halide or aralkyl halide for a period of time, and at a sufficient temperature, to form mono-reactive dendrigraft polymers.

In accordance with this aspect of the invention, a method of forming a branched polymer capable of achieving high molecular weight product comprises polymerizing a monomer that leads to linear segments that form a reactive end group that is in an electrophilic or nucleophilic condition. The chain end, during a portion of the polymerization reaction, is then susceptible to reversing its electrophilic or nucleophilic character, such that conversion from electrophilic to nucleophilic or from nucleophilic to electrophilic occurs by reaction with a chain transfer agent.

The polymerizing linear polymer chains are exposed to a chain transfer agent so that the reactive end group of a growing linear polymer chain reverses its electrophilic or nucleophilic character. Thereafter, a non-reversed reactive end group on a second growing linear polymer chain reacts with the reversed reactive end group on the first polymerizing linear polymer chain to create a branched polymer.

During this reaction wherein the non-reversed reactive end group of a second growing linear polymer reacts with the reversed reactive end group of a first growing linear polymer, the electrophilic or nucleophilic character of the reversed reactive end group is again reversed back to it first condition. Upon being reversed to its original condition, the end group that was originally part of the first growing polymer chain reacts with a monomer from which linear polymerization proceeds. Thereafter, the resulting branched polymers having an electrophilic or nucleophilic end group are reacted with a compound having multiple reactive sites capable of reacting with the reactive end groups of the polymer chains when they are in the first condition, whereby a branched polymer is formed from a monomer that is protected against branching.

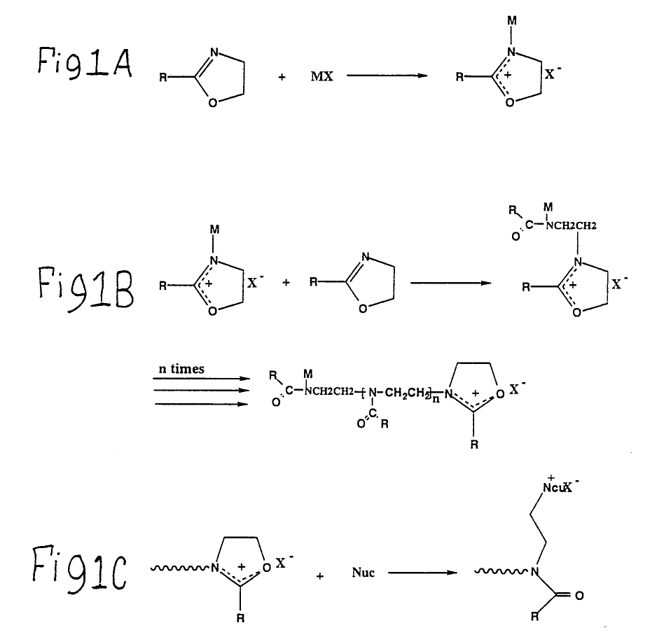

As disclosed Supra, FIGS. 1A, 1B, 1C, 2, 3A and 3B, set forth a schematic diagram of the reaction schemes wherein ethyl(oxazoline) is shown as the polymerizable monomer,

The polymerization goes through three steps: initiation, i.e. FIG. 1A, propagation, i.e. FIG. 1B, and termination, i.e. FIG. 1C.

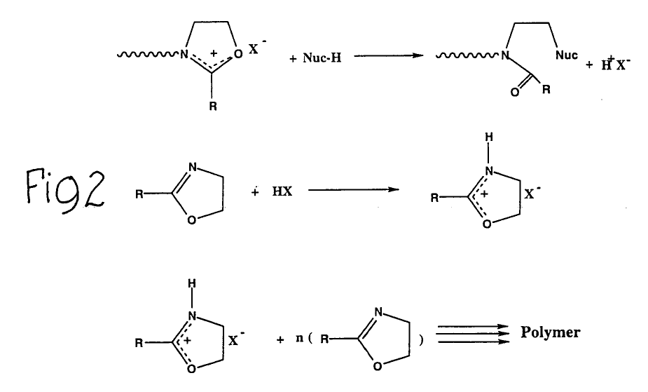

If the cationic polymerization is used and the reaction is controlled carefully, the linear polyoxazoline with low polydispersity can be obtained. However, if there are nucleophiles with an active hydrogen in the reaction system, the chain transfer would take place, i.e. FIG. 2.

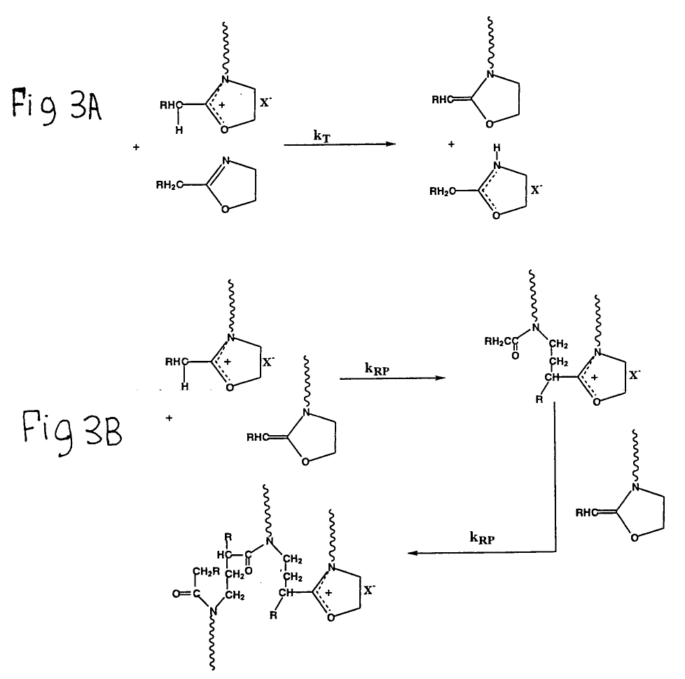

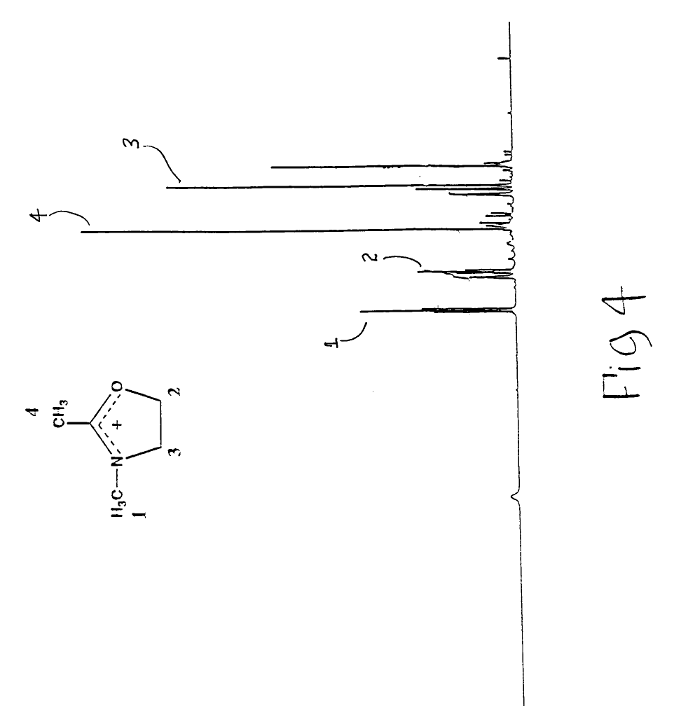

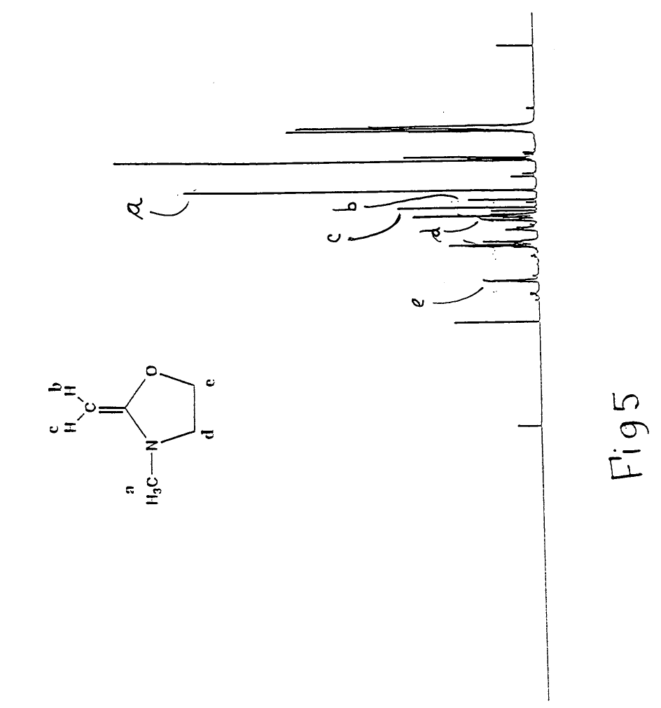

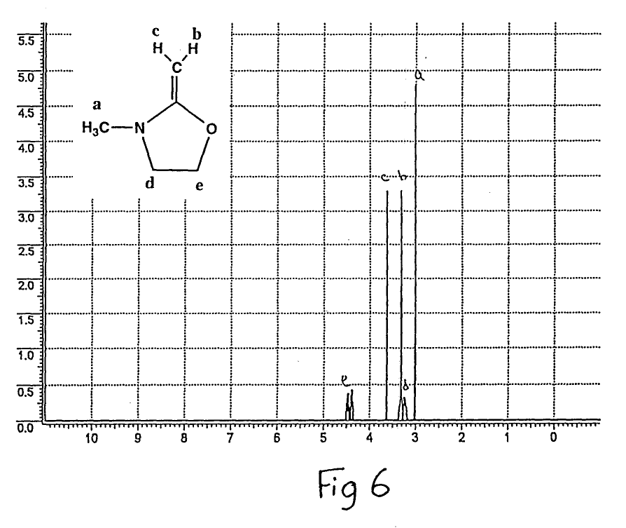

FIGS. 3A and 3B show an alkyl oxazoline polymerization with high monomer to initiator ratio and chain transfer along with repolymerization.

There is disclosed the production of ultra-high molecular weight dendritic polymers in which the branching junctures are assembled in situ, that is, self-branching, through a convergent manner during the polymerization of commercially available monomers.

In contrast to the polycondensation of ABₓ monomers, in which interior branching junctures have been previously built into the monomers, the self-branching polymerization generates branching junctures during the polymerization of the monomers. The divergent self-branching polymerization amplifies its reactive chain ends and allows them to branch from an inside core to outside terminal groups, while convergent self-branching polymerization combines the reactive chain ends and allows them to branch from the outside terminal groups to the inside core. The best example of divergent self-branching polymerization is Frechet's self-condensing vinyl polymerization, in which both an initiating center and a propagating center are present in each AB monomer, and the branching junctures are generated through simultaneous and continuous initiating and propagating processes during the polymerization. In the case of convergent self-branching polymerization, in addition to chain propagation, a chain branching reaction also occurs during the polymerization.

A chain transfer reaction from an active chain end to a monomer generates an initialization site leading to a new macromonomer, as well as another new active chain end. This reactive macromonomer can then be combined with a new or another active chain end to generate a dimer-like molecule with a new active polymerization site in the middle of the polymer chain. The resulting polymerization site can further propagate with more monomer to form a Y-shape branched molecule with a newly generated reactive chain end at one terminus. This newly generated reactive chain end can again chain transfer and react with more monomer until all the monomer is consumed producing a population of single site reactive dendrigrafts.

If the terminating moiety is a monofunctional core molecule, a dendron-like, hyper-branched polymer will be formed. If a multifunctional or dendrimer core is utilized, a dendrimer-like, spherical, hyper-branched polymer will be generated. Similarly, if a multifunctional linear polymeric core is used, a dendrigraft-like hyper-branched polymer will be obtained.

A fundamental difference between traditional linear polymerization and a self-branching polymerization is that the former prefers one reaction pathway, that is, propagation, while the latter undergoes two or more reaction pathways, that is, propagation and chain transferring resulting in branching.

For example, in a traditional vinyl or ring-opening polymerization process as disclosed supra, one reaction pathway, i.e., initiation and propagation, is often preferred in order to produce pure linear polymers. However, in reality, it is very difficult to control the polymerization conditions that would allow the desired reaction pathway to occur. In most cases, there are always some side reactions occurring during the polymerization process that generate undesired side products such as pre-terminated low molecular weight linear polymers, cyclic polymers, chain transfer capable polymers, and branched polymers. If the undesired side reaction can be suppressed and the desired side reaction can be promoted, in addition to polymer chain propagation, the conventional polymerization processes that were widely used to produce one-dimensional linear polymers could also be utilized to prepare mono-reactive dendrigraft, tree-like polymers.

The process of this invention is dependent on several parameters. At the outset, it should be understood by those skilled in the art of convergent polymerizations, that control of three of the parameters is important, namely, (a) control of the chain propagation, (b) control of chain transfer and, (c) control of re-polymerization.

In addition, it is important to control the initiator to polymerizable monomer ratio, type of initiator, and the types of polymerizable monomer, in order to be successful using this method.

For example, the initiators useful in this invention are alkyl halides, and aralkyl halides, materials having less ionic character than the sulfonic acids and other Bronsted acids. These initiators, as opposed to sulfonic acids as an initiator, are slower types of initiators, that is, less ionic, and provide a situation where the chance for chain transfer is enhanced, and the amount of branching and polymerization of the branches with regard to the rate of linear chain propagation is enhanced. The initiator, p-toluene sulfonic acid (p-TSA), has been used unsuccessfully to achieve the materials of this invention as this initiator produces polymers having primarily the linear product with only a few dispersed branched molecules. Without the inventive type of initiator, or in the presence of initiators such as p-toluene sulfonic acid, the preferred materials of this invention will not be obtained. Thus, this invention is limited to the use of alkyl halides and aralkyl halides as initiators. Preferred for this invention are alkyl halides having from 1 to 22 carbon atoms, wherein the halides are preferred to be bromide and chloride. Also preferred for this invention are aralkyl halides having 6 to 30 carbon atoms, such as benzyl halides, such as benzyl bromide and benzyl chloride, and 1,2,4,5-tetrakis(bromomethyl)benzene.

Moreover, the polymerizable monomers of this invention are those monomers that have at least one hydrogen alpha to the oxazoline or oxazine ring, and it has been discovered that the more alpha hydrogens that are present, the more efficient is the participation of the monomer in the desired branching Therefore, the monomers of this invention as starting materials, have to have at least one hydrogen alpha to the heterocyclic ring, and it is preferred that there are at least two such alpha hydrogens in the monomer. It is contemplated by the inventors herein that two or more types of such monomers can be copolymerized in this invention.

The materials of this invention are obtained by the use of higher monomer to initiator ratios (M/I ratios). The materials of this invention have, generally, monomer/initiator ratios higher than 100. Increasing the monomer concentration up to an M/I ratio of about 500 leads to an enhanced percentage of higher molecular weight products when using the preferred initiators of this invention. The reactions of this invention are usually carried out in the temperature range of 0° C. to 250° C. and the reaction times can vary from about 1 hour to about 48 hours.

The properties of these new materials derived by the method of this invention include properties that are markedly different from those associated with and obtained from traditional linear, branched or cross-linked architectures. These new properties include dramatically smaller size/weight ratios, lower bulk viscosities, higher solubility's, lower intrinsic viscosities, Newtonian rheology, exponentially larger numbers of terminal groups, and controlled interior void spaces, as compared to their linear counterparts.

In a further embodiment of this invention, the materials described herein can be reacted with, that is, quenched with, any of the various compounds having multiple reactive sites capable of reacting with the reactive end groups of the various polymer chains described above. For example, in the case of poly(ethyloxazolines), these compounds can be contacted with a linear polyethyleneimine having a plurality of nucleophilic reactive sites that can combine with poly(ethyloxazoline) single-site reactive dendrigrafts having electrophilic sites. The quenching substrate having multiple reactive sites capable of reacting with the reactive end groups on the single-site reactive dendrigraft can be generally any molecular architecture. For example, in the case of the poly(ethyleneimine) quenching substrate, the poly(ethyleneimine) can be linear, including rigid rods, and cyclic or closed linear polymers; cross-linked polymers, including lightly cross-linked polymers, densely cross-linked polymers, and interpenetrating networks, branched polymers, including random short branched polymers, random long branched polymers, regular comb-branched polymers and regular star-branched polymers, or dendritic polymers, including random hyper-branched dendritic polymers, dendrigrafts, dendrons, and dendrimers.

The polymers of this invention can be advantageously employed in various applications including Ag/Pharma delivery, lubricants, adhesives, rapid cure coatings, composites, crosslinking agents, metal chelation, gene transfection, diagnostic assays, MRI agents, water treatments, environmental remediation, paper finishing chemicals, viscosity modifiers, antistatic agents, ceramic fabrication, polymer additives, ink-jet printing, photographic reagents, reprography reagents, chromatography supports/ion exchange resins and electrophoretic gels.

Now so that those skilled in the art may better understand the invention, the following examples are provided.

### EXAMPLES

Comparative examples—Preparation of hyper-branched polyethyloxazoline polymers of the type HBP-5xxx-xx using prior art, highly ionic p-toluene sulfonic acid as the catalyst. (Not within the scope of this invention)

For purposes of the examples set forth herein, the designation HBP-xxx-xx has the following meaning: HBP means “hyper-branched polymer”; the first set of numbers means the “degree of polymerization”, or the M/I ratio of the polyethyloxazoline (or other polymer prepared using the method of this invention), and the second set of numbers refers to the degree of polymerization of the quenching polymer.

The materials methyl p-toluenesulfonate, p-toluenesulfonic acid, morpholine, and diisopropylethylamine were all purchased from Aldrich Chemical Co. Milwaukee, Wis. The material 2-ethyl(oxazoline) was obtained from Solutia Chemical St. Louis, Mo. Toluene, methylene chloride, diethyl ether, and methanol all were purchased from Fisher Scientific Co. Methyl p-toluenesulfonate was purified by vacuum distillation, while 2-ethyloxazoline, morpholine, diisopropylethylamine, toluene, and methylene chloride were all stirred over CaH₂ and distilled prior to use herein.

Analysis of some of the materials herein was carried out using size exclusion chromatography (SEC) and matrix assisted laser desorption ionization/time-of-flight mass spectrometry (MALDI-MS).

This synthesis of hyper-branched polyethyloxazoline is provided as a general procedure for the preparation of hyper-branched polymers and is used for comparisons herein.

### Example 1

(Not within the scope of this invention but submitted to show the basic reaction conditions to form PEOX using p-toluene sulfonic acid.)

A mixture of p-toluene sulfonic acid (1.92 g, 0.01009 mol) in 500 ml of toluene was azeotroped to remove water using a distillation head under N₂ for about 15 minutes. After cooling to about 60° C., 2-ethyloxazoline (500 g, 5.045 mol) was added drop wise through an addition funnel, and the mixture was allowed to reflux between 6 and 24 hours and then terminated with morpholine. The degree of polymerization (DP) was controlled by the ratio of initiator to monomer.

### Example 2

(Not within the scope of this invention but submitted to show the conditions for standard acid hydrolysis of polyethyloxazoline to polyethyleneimine.)

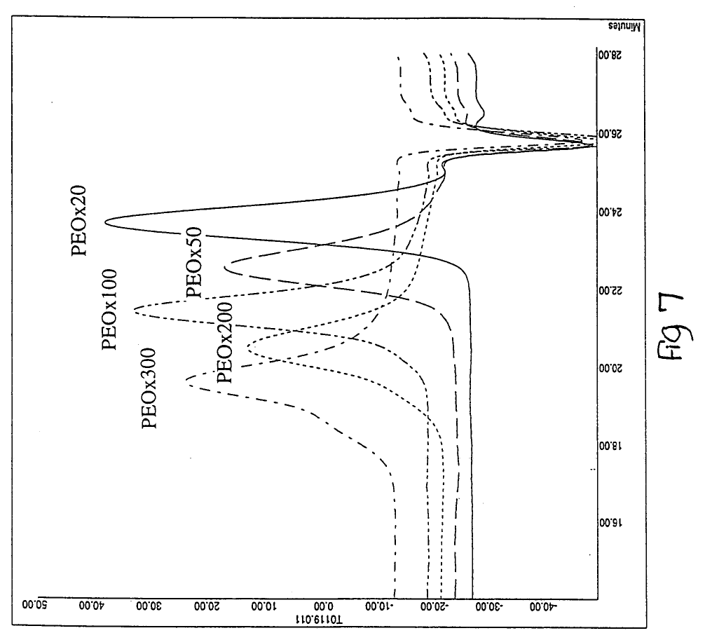

To the mixture of example 1 was added a linear polyethyleneimine core (0.015 mol of NH, 1.5 eq), which was dried by azeotropic distillation from toluene, followed by immediate addition of diisopropylethylamine (2 eq.). The mixture was refluxed for 2 hours, cooled, and the top toluene layer was decanted off. The crude product was redissolved in methanol and then precipitated from a large excess of diethyl ether. The bottom layer was redissolved in methanol and dried by rotary evaporation and vacuum to give a PEOX hyper-branched polymer as a white solid, approximately 500 g., having a molecular weight of greater than 1,000,000, and a Tg of approximately 40° C. The results are shown in FIG. 7.

### Example 3

(Not within the scope of this invention but submitted to shown the effect of M/I, with ionic initiators.)

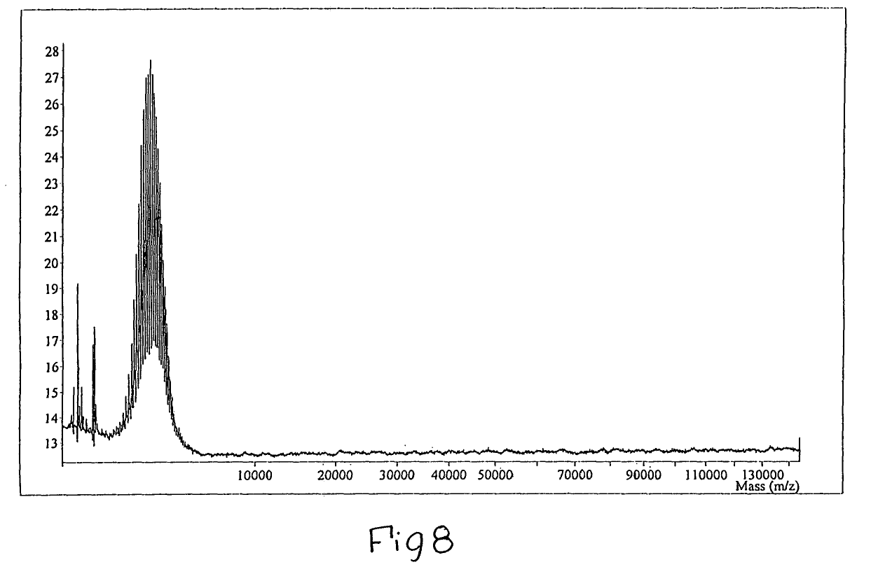

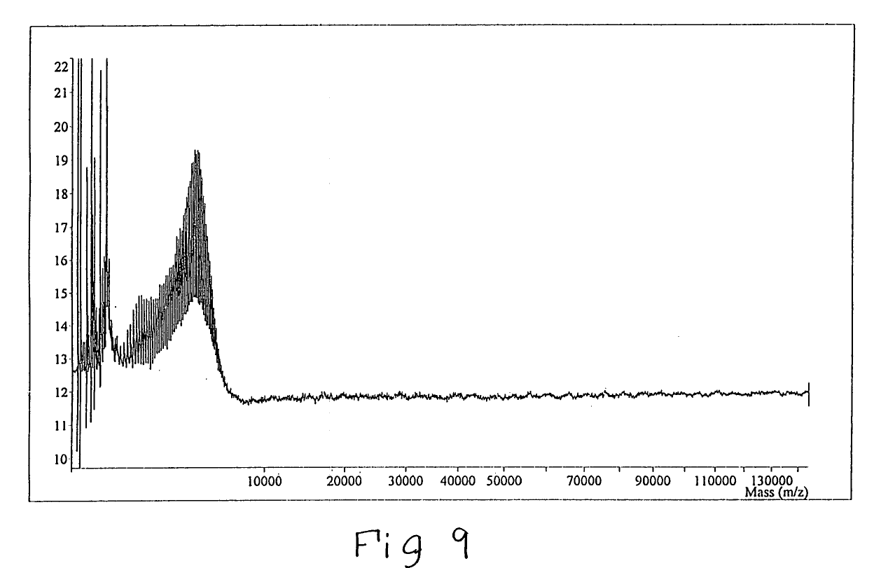

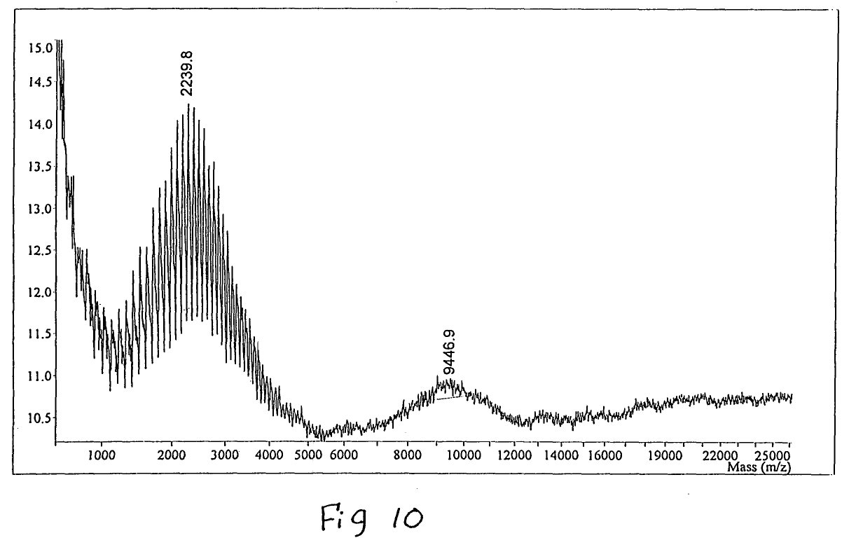

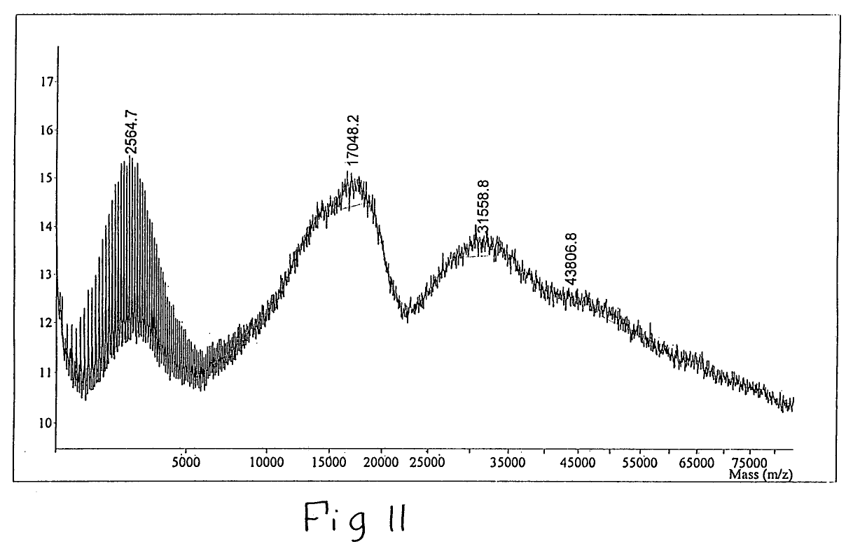

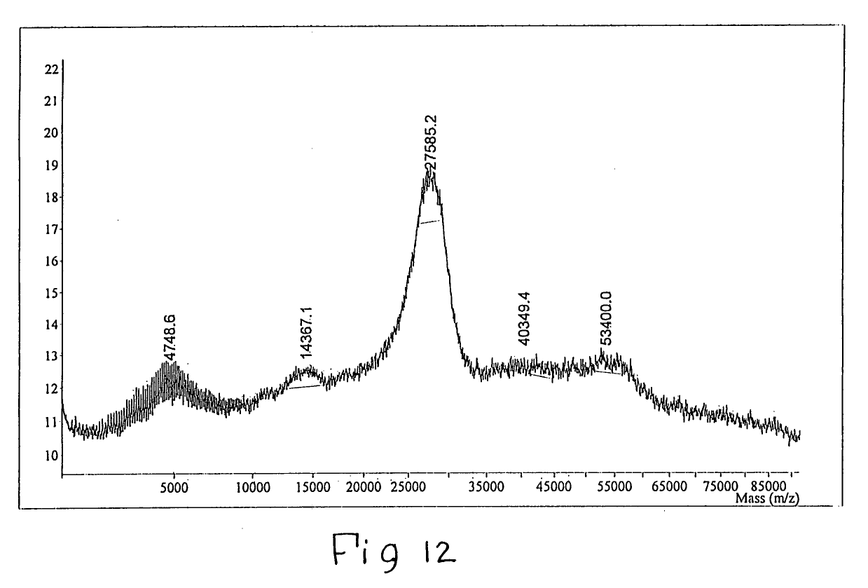

A number of preparations were made as described above but using a variety of monomer to initiator molar ratios including 20, 50, 100, 200, and 300. It was fund that at high monomer to initiator ratio of greater than about 200, in addition to the expected increases in molecular weight, a new, higher molecular weight shoulder band appears on the molecular weight peaks and the molecular weight dispersion broadens significantly as shown in the size exclusion chromatographs below. These data show that at increasing monomer to initiator ratios, not only does the molecular weigh increase, but also there is formation of distinct high molecular structures. Above M/I ratios of 500, the high molecular weight component becomes the dominant fraction. In the case of PEOx20 to PEOx100, the molecular weights obtained from MALDI-MS were very close to the theoretical molecular weight calculated by DP (1980, 4950, and 9990). In the case of PEOx200 and PEOx300, the molecular weight of major peak is a little lower than the calculated figure (19800 and 29700), but the peaks are nearly double and even triple in size as theoretical molecular weight can be found in the MALDI-MS Figures. See FIGS. 8 to 12.

### Example 4

(Not within the scope of this invention but submitted to show the use of monomers with a third alpha hydrogen that enhances branching.)

The homopolymerization of 2-methyloxazoline was carried out under conditions similar to those described in Example 1 above, except the M/I ratio was 50. The theoretical molecular weight for simple linear polymerization should be M_{theoretical}=4,344. However, use of this activated monomer led to the formation of much higher high molecular weight dendrigraft structure of Mₚ=26,000.

### Example 5

(Not within the scope of this invention but submitted to show the copolymerization with monomer with a third alpha hydrogen.)

Copolymerization of a combination of 2-methyloxazoline with 2-ethylozazoline under the conditions in Example 1 above, but with an M/I ratio of 50 would give a theoretical molecular weight of M_{theoretical}=4,693 but actually resulted in a dendrigraft copolymer of Mₚ of up to 31,972.

### Example 6

### Within the Scope of This Invention

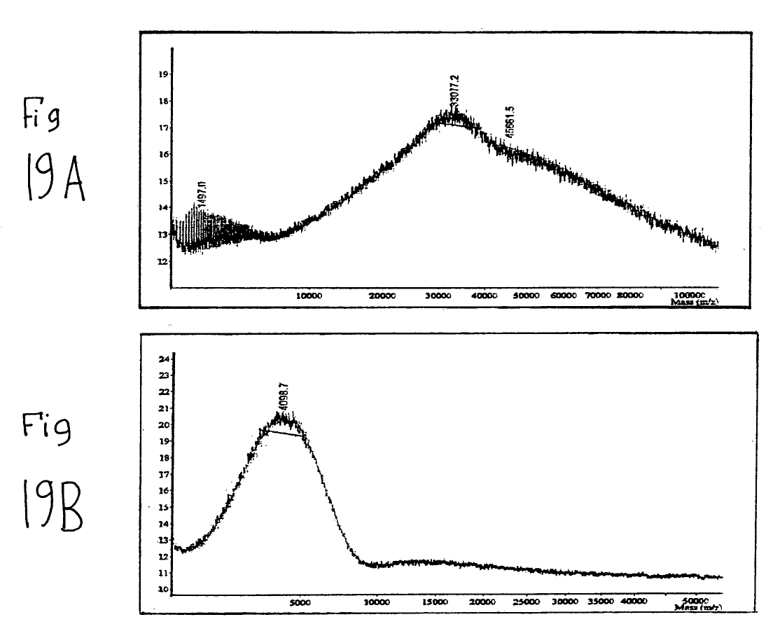

Polymerization of 2-ethyloxazoline as in Example 1 above, but using a monomer to initiator ratio of 100 and substituting the alkylbromide CH₃(CH₂)₁₇Br for the p-toluene sulfonic acid initiator. The combination should have given a linear polymer of M_{theoretical}=10,000, but resulted in predominantly higher molecular weigh dendrigrafts of Mₚ₁=33.077 and Mₚ₂=45,662 as shown in FIG. 19A. FIG. 19B shows the hydrolysis of the polyethyloxazoline dendrigraft to a polyethyleneimine dendrigraft. The large reduction in molecular weight indicated a highly branched dendritic structure. The molecular weight of the polymer of FIG. 19B resulting from the hydrolysis was 4,098 which was much lower than would be expected if the polymer was a linear polyethyloxazoline wherein theoretically, hydrolyzed=Mₚ₁=14,223 and Mₚ₂=19,635. This dramatic reduction in molecular weight is an indication of hydrolysable amide linkages at the branch points in a dendrigraph polymer structure of this invention.

### Example 7

### Polymerization of 2-ethyloxazoline Using C₁₂ Bromide Initiator

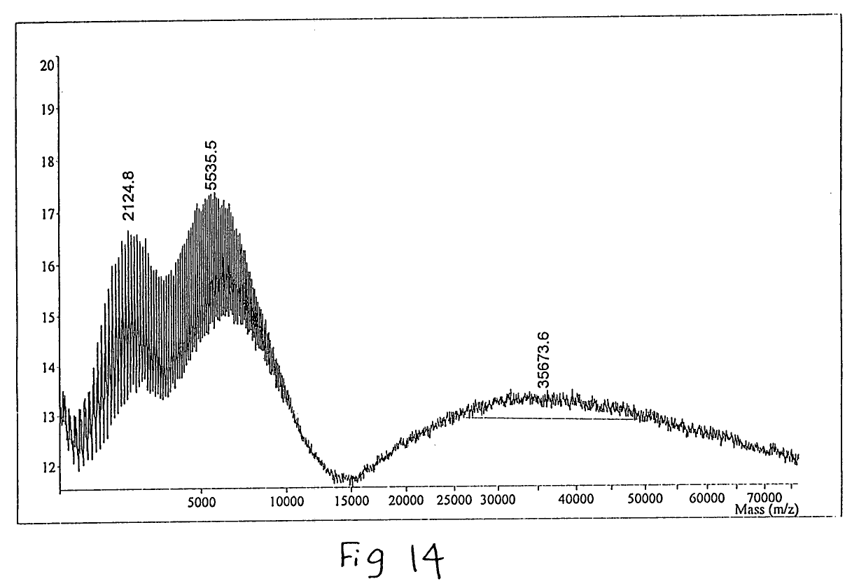

The reaction was carried out as in Example 6. The result was a peak mixture of 2124.8 and 5535.5 of PEOx20 and di-PEOx20 and tri-PEOx20, of which molecular weights are 2229, 4458, and 6687, respectively by calculation. FIG. 14.

### Example 8

### Polymerization of 2-ethyloxazoline Using C₁₈ Initiator

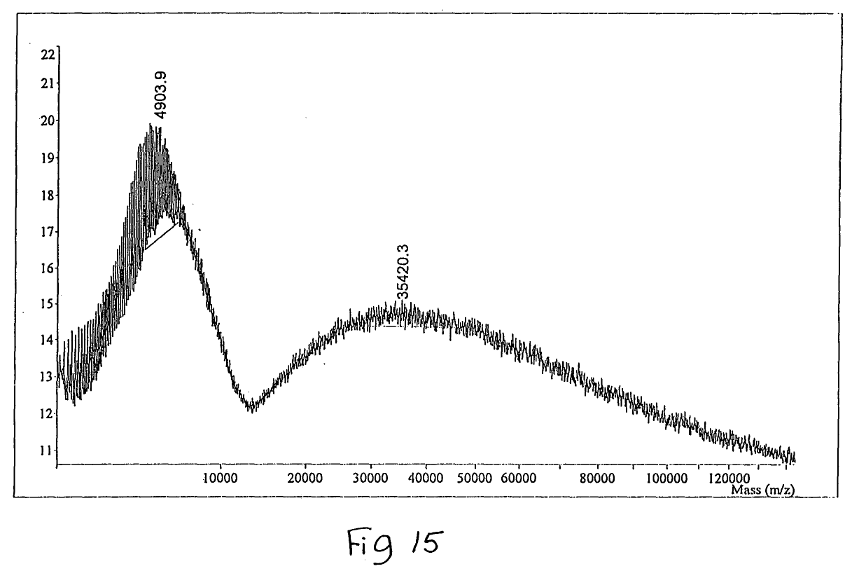

The reaction was carried out as in Example 6. The result was two peaks appearing in MALDI-MS, FIG. 15. The peak in the low molecular area is 4903. It was very close to the di-PEOx20 (calculated MW=4626). The other peak was a wide peak in the high molecular weight area.

### Example 9

### Polymerization of 2-ethyloxazoline Using C₂₂ Initiator for a Series of Polymerizations of Different DP.

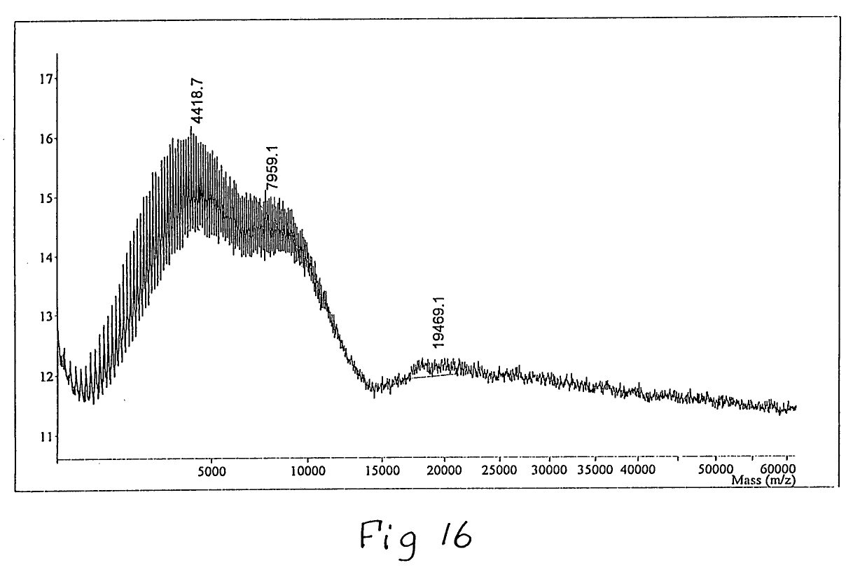

The reaction was carried out as in Example 6. The result was a mixture of peaks of 4418.7 and 7959.1 with di-PEOx20 and tri-PEOx20 calculated as 4738 and 7107 and, a little peak in the high molecular weight area as shown in MALDI-MS. See FIG. 16.

### Example 10

### Polymerization of 2-ethyloxazoline Using C₁₈ Initiator

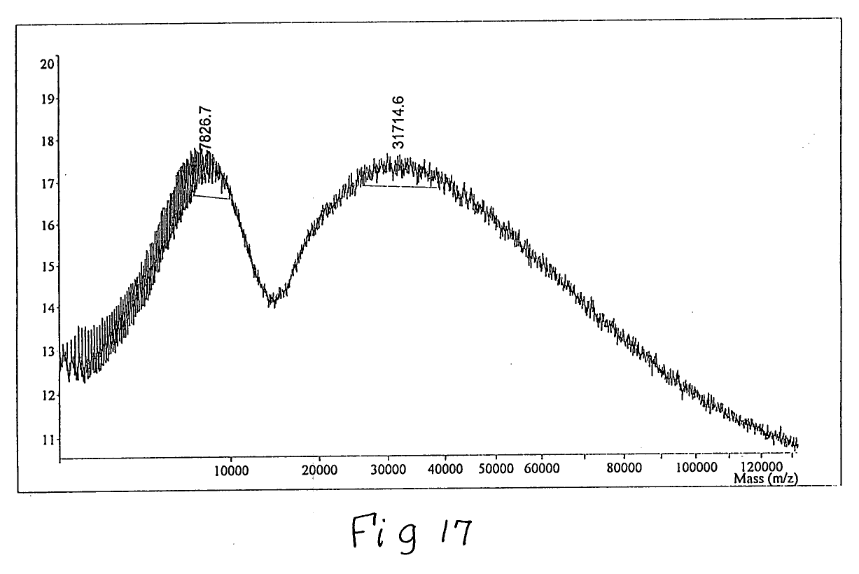

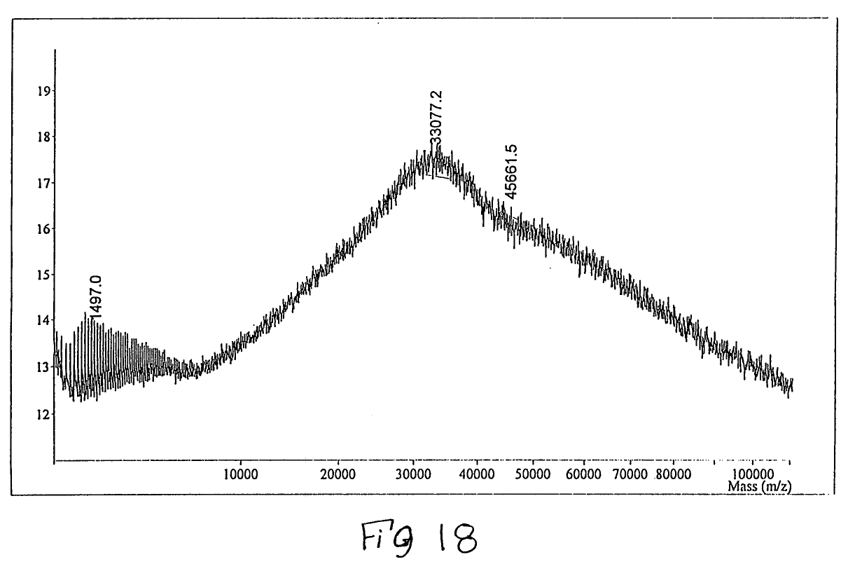

The reaction was carried out as in Example 6. The result was a mixture of two peaks shown in FIG. 17. For PEOx100, only one wide peak showed in the MALDI-MS. See FIG. 18.

### Example 11

### The Use of Benzyl Bromide Initiator at Higher M/I Ratios

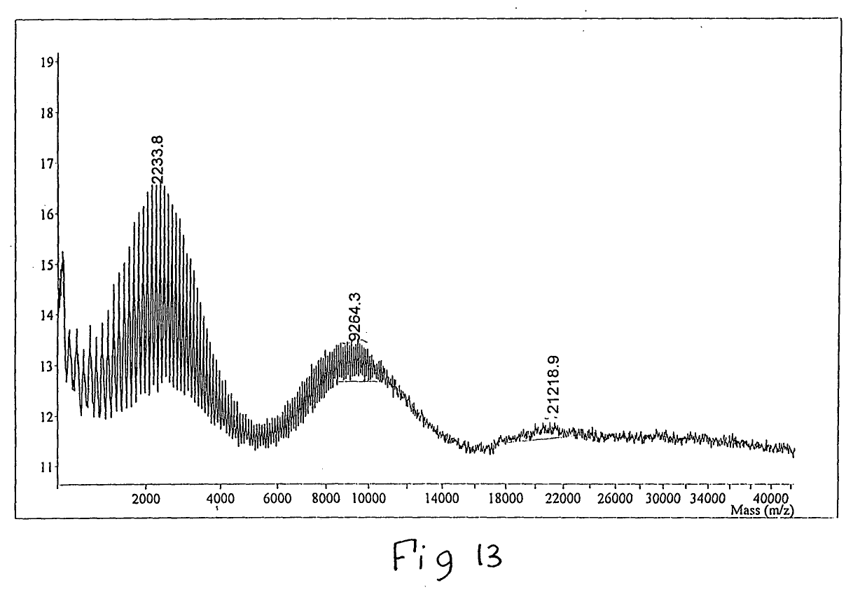

Ethyloxazoline was polymerized as described using benzylbromide as an initiator at a M/I of 500. A very high molecular weight of M_{w}=101,000 with a broad molecular weight distribution of MWD=1.73 resulted. See FIG. 13.

### Example 12

### The Use of Multifunctional Initiators

Use of 1,2,4,5-tetrakis(bromomethyl)benzene as an initiator resulted in polymers with multiple peaks by SEC, including some low molecular weight tetra-armed star polymers and the remaining polymer being of high molecular weight, soluble branched structure. Complete acid hydrolysis of this polymer resulted in PEI star polymers with monomodal molecular weight distribution.

These examples demonstrate that the branch density of these polymers can be controlled and enhanced by high M/I ratios, high conversions, monomers possessing more alpha hydrogens and, using less ionic initiators.

1. A method of preparing mono-reactive dendrigrafts by convergent self-branching polymerization, the method comprising reacting and polymerizing a monomer having at least one α-hydrogen, and that is protected against branching, and that forms a reactive end group that is in a first condition which is one of electrophilic character or nucleophilic character, and that at least during a portion of the polymerization reaction, is susceptible of reversing its electrophilic or nucleophilic character from one of electrophilic character or nucleophilic character to the other, by reaction with a chain transfer agent, in the presence of a halide selected from the group consisting of:
(i) alkyl halides and
(ii) aralkyl halides,
for a sufficient period of time and at a sufficient temperature to form a mono-reactive dendrigraft polymer.

2. A mono-reactive dendrigraft prepared by the method of claim 1.

3. An ultra-high molecular weight polymer prepared by grafting the mono-reactive dendrigraft polymer of claim 1 with a material selected from the group consisting of:
(i) linear polymers,
(ii) dendritic polymers,
(ii) dendrigraft polymers,
(iii) branched polymers, and
(iv) hyper-branched polymers.

4. A method as claimed in claim 1 wherein the initiator is an alkyl halide.

5. A method as claimed in claim 4 wherein the alkyl halide is an alkyl halide having from 1 to 22 carbon atoms.

6. A method as claimed in claim 5 wherein the alkyl group is methyl.

7. A method as claimed in claim 5 wherein the alkyl group is octadecyl.

8. A method as claimed in claim 1 wherein the initiator is an aryl halide.

9. A method as claimed in claim 8 wherein the aryl halide is an aryl halide having from 6 to 30 carbon atoms.

10. A method as claimed in claim 9 wherein the aryl group is benzyl.

11. A method as claimed in claim 9 wherein the aryl group is 1,2,4,5-tetrakis(bromomethyl)benzene.

12. A method as claimed in claim 1 wherein the monomer itself is capable of functioning as a chain transfer agent at least during a portion of said polymerization.

13. The method as claimed in claim 1 wherein the monomer is selected such that the linear polymer chains that it forms grow to degrees of polymerization in excess of about 100 before the electrophilic or nucleophilic character of said reactive end groups is capable of being reversed by exposure to remaining monomer units acting as chain transfer agents.

14. The method as claimed in claim 1 wherein the chain transfer agents are not introduced into said reaction vessel until after the polymerization has been allowed to proceed for a time sufficient to yield linear polymer chains of a desired degree of polymerization.

15. The composition of claim 3 wherein the composition has a molecular weight of at least 100,000.

16. The composition of claim 3 wherein the composition has a molecular weight of at least 500,000.

17. The composition of claim 3 wherein the composition has a molecular weight of at least 1,000,000.

18. The composition of claim 2 wherein the mono-reactive polymer is polyethyloxazoline.

19. The composition of claim 3 wherein the grafting polymer is polyethyleneimide.
